(19) United States
(12) Patent Application Publication
(10) Pub. No.: US 2009/0144802 A1
(43) Pub. Date: Jun. 4, 2009

(54) Large scale identity management

(75) Inventors: Steve Tillery, Naples, FL (US); Anil Saraswathy, Trivandrum (IN)

Correspondence Address: NIXON & VANDERHYE, PC, 901 NORTH GLEBE ROAD, 11TH FLOOR, ARLINGTON, VA, 22203, US

(73) Assignee: Fischer International Identity LLC, Naples, FL (US)

(21) Appl. No.: 12/292,047

(22) Filed: Nov. 10, 2008

Related U.S. Application Data
(60) Provisional application No. 60/987,430, filed on Nov. 13, 2007.

(51) Int. Cl. G06F 21/00

(52) U.S. Cl. 726/1

(57) ABSTRACT

Methods of designing, structuring and operating an Identity Management provisioning solution over multiple sets of hardware/software platforms are organized by “area of expertise” to better utilize IdM deployment and support team resources for subject matter expertise, improving quality, consolidating resources, and significantly reducing the cost of IdM deployment and operation, across the entire MSP customer base. For example, IdM events originate in a source system platform and flow into a large scale Identity Management infrastructure platform, where IdM event filtering occurs, source system lookups or source system exports occur, provisioning policies or rules are applied to determine which accounts and/or entitlements need to be provisioned or de-provisioned in target connected systems, and target system imports are executed to accomplish the provisioning or de-provisioning activities.

### CROSS-REFERENCES TO RELATED APPLICATIONS

This application claims the benefit of Provisional Application No. 60/987,430, filed Nov. 13, 2007, the entire content of which is hereby incorporated by reference in this application. This application is related to U.S. application Ser. No. 11/783,894, entitled CROSS DOMAIN PROVISIONING METHODOLOGY AND APPARATUS, filed on Apr. 12, 2007 by Saraswathy et al., which application is incorporated herein by reference in its entirety.

### TECHNICAL FIELD

The illustrative implementations generally relate to a method of operating a large Identity Management (IdM) resource provisioning infrastructure for, for example, hundreds of organizations. The illustrative implementation relates to a software based provisioning topology that can provide a large managed service provider with an infrastructure for managing digital identities among, for example, hundreds of organizations, as well as across their IT organizational boundaries.

### BACKGROUND AND SUMMARY

### Identity Management (IdM) Overview

The primary driver for Identity Management (IdM) solutions is an organization's need to meet regulatory compliance requirements in order to avoid a failed security audit. Other benefits include streamlined administration processes, improved help desk operations, and the return on investment (ROI) associated with improving those processes. Without IdM, disparate administration groups are challenged with the responsibility of provisioning and de-provisioning user accounts, there is no central control, no central audit trail of the activity, no history, no accountability for why an account is created, or why particular permissions have been granted to various users. There is also no coordination or methodology linking a users accounts across platforms and systems. Typically, when employees, partners, or consultants leave the organization, their accounts are not de-provisioned on a timely basis creating security vulnerabilities, regulatory compliance violations, best practice security violations, and in general generating huge security infrastructure problems.

Identity Management (IdM) may be viewed as the capability to manage user accounts across a wide variety of IT systems. An Identity Management (IdM) solution automates the administration processes associated with provisioning user accounts and entitlements or access rights, de-provisioning accounts when a user leaves the organization, and offers approval services for these various provisioning processes. An IdM solution offers end-user self-service and delegated administration capabilities for managing user attributes, passwords, and user self-service provisioning requests for access to IT systems. An IdM solution also provides integration with a wide variety of IT systems that a given organization may be running. In addition, IdM solutions provide organizations with Regulatory Compliance reporting and assessment capabilities.

### Conventional IdM Provisioning Solutions

Conventional Identity Management offerings are typically comprised of disparate point products such as password management, meta-directory, or provisioning products that were acquired to round out the IDM suite of features. Because these point products were designed separately, they require numerous integration points, multiple and complex administration, invasive agent technologies, and disparate audit log files, requiring a great deal of programming, and scripting to get the various point products to work together. Unfortunately, these solutions typically lack cohesion across IDM features, they lead to long implementations times, lower quality, and higher costs. After such a solution is deployed, the organization is typically left with a solution that is not maintainable, creating the need for repeat professional services work to maintain or extend the solution for future requirements.

Conventional IdM provisioning technologies/solutions are typically deployed to solve one organization's IdM related problems. A conventional IdM deployment project typically takes place at the customer organization's IT data center where the customers IT systems are operating. The IdM solution is typically deployed on middleware platforms in the organization's IT data center, and it integrates with all or many of the organization's IT systems and platforms, in order to automate IT system administration and provide audit and compliance capabilities to the organization.

Deficiencies To Avoid In IdM Provisioning Solutions:

Conventional IdM technologies/solutions typically do not permit, and are typically missing the following solution concepts:

1. They typically do not permit multi-tenancy operation where multiple organizations are supported by one solution.

2. They typically do not permit on-demand operation where multiple organizations are managed centrally

3. They typically do not permit centralizing IdM deployment and support, maximizing the use of IdM resources across multiple organizations and achieving economies of scale that give the MSP a significant advantage over separate IdM systems

4. They typically do not permit the IdM solution to be partitioned into work function areas and technology areas where teams of solution area experts can focus their specialized skills and where costs can be shared across organizations

5. Conventional IdM technologies/solutions typically do not permit a solution topology where centralized teams of IdM resources can be organized by “subject matter expertise”, providing IdM deployment and support services, for one area of the solution, to multiple organizations.

6. They typically do not permit an MSP Client Organization concept required for multi-tenancy operation. They are not architected to allow policies, procedures, solution configurations, and data to be managed separately by organization, thus providing a basis for the information to be securely isolated between organizations.

7. They typically do not provide rapid deployment methodologies for on-boarding new client organizations into an on-demand multi-tenancy delivery model.

8. They typically do not provide seamless cross domain operation required for operating an IdM solution in the on-demand multi-tenancy delivery model.

As defined by the Wikipedia, multi-tenancy refers to the architectural principle, where a single instance of the software runs on a software-as-a-service (SaaS) vendor's servers, serving multiple client organizations (tenants). Multi-tenancy is contrasted with a multi-instance architecture where separate software instances (or hardware systems) are set up for different client organizations.

It should be understood that any illustrative embodiment of the present invention may have one or more of the deficiencies of conventional IdM technologies/solutions described herein. Such illustrative implementations will, however, include unique features described herein that distinguish over the conventional approaches alluded to herein. The scope of the claimed invention should in no way be limited by the discussion herein of deficiencies in typical convention IdM technologies. Rather, the scope of the invention should be construed in light of the ordinary meaning of the claims appended hereto.

FIG. 1 shows a conventional IdM provisioning solution and platform. Regardless of the chosen vendor technology, the main components of IdM solutions (1-6, and A-E) are installed on a middleware platform(s), and the IdM solution integrates with the organization's IT systems (7-11) to automate IdM related administration activities.

IdM provisioning solutions have provisioning solution objects. The objects include, connected systems, triggers, provisioning rules or policies, approval processes, IdM attribute mappings, and IdM groups.

Provisioning Object Definitions:
Connected Systems—The IT systems that participate in the IdM provisioning solution, as source or target systems.
Triggers—Configurations that define IdM events that need to be processed.
Provisioning Rules or Policies—Configurations that define how to process an IdM event (e.g. new hire, termination)
Approval Processes—Configurations that define who must approve an IdM provisioning event.
IdM Attribute Mappings—Configurations that define how to map and transform IdM attributes from source system schema to target system schema.
IdM Groups—A community of Identities or people.

These objects typically must be configured. The configurations (FIG. 1 (2)) for conventional IdM solutions are made up of scripts, control files, and browser based configurations, possibly managed in an LDAP directory.

Conventional IdM Provisioning Process Flow—FIG. 1 shows a conventional IdM provisioning process. The process might start with a provisioning event in a source connected system (7), possibly an HR new hire event. The new hire IdM event causes an event trigger to fire, sending the event to the provisioning platform, via a system specific connector (A). The solution configuration rules (2) are used to determine how to process the event.

1^{st} the event is filtered (3), or validated as an event that the solution must process.

2^{nd} the event may require additional IdM data, or the execution of source system exports (4), and the collection of IdM data may need to be transformed, or mapped into a different format for IdM provisioning policy execution (Table A represents an example of input to next part of the process Provisioning Policy Execution).

3^{rd} the policy execution phase (5) uses Identity attribute input to evaluate conditions as being true or false to determine which systems or applications and entitlements the new employee needs access to. Example provisioning policy conditions could be:
Employee-Status=new-hire
Employee-Type=permanent
Job-Department=sales
Location-City=Boston

An example provisioning policy/rule of Employee-Type=permanent could mean the new employee is a permanent employee that must have access to the organization's internal network and e-mail application. Job-Department=Sales and Location-City=Boston might mean this user requires access to the organization's sales and CRM systems for the northeastern United States. An IdM provisioning configuration for one organization could have hundreds of these policies or rules.

4^{th} after policy execution, the next phase of the process is target system import (6). The staged identity input (Table-A), along with the output from the policy execution, determines which target systems and entitlements the new employee might need. During target system import (6) the Identity data (Table-A) is mapped to target system specific schema.

An example of attribute mapping for Active Directory might be:

GivenName=Person-FirstName

Sn=Person-LastName

sAMAccountName=Account-ID

department=Job-Department

title=Job-Title

email=Person-FirstName.Person-LastName+‘@domain.com’

telephoneNumber=Employee-Phone

street=Location-Street 1

1=Location-City

st=Location-State

postalCode=Location-PostalCode

After the mapping operation the Import operation to Active Directory (8) via the Active Directory connector (B) is executed.

No Concept Of Provisioning Solution Areas—Although all IdM provisioning solutions need to execute the functionality described by the four phases (FIG. 1 (3)-(6)) of a provisioning solution (FIG. 1 (1)), conventional IdM provisioning solutions typically do not have these provisioning process phases (FIG. 1 3-6) well structured. They typically have portions of this functionality embedded in a script, other portions configured to execute as part of the out-of-the-box capabilities, and sometimes portions that execute as part of the target system connector configuration.

Conventional IdM technologies/solutions typically do not permit the IdM solution to be divided into solution areas, where each solution area can be managed by teams of solution area experts, providing IdM services for their area of expertise to multiple client organizations.

Topology Not Organized by “Subject Matter Expertise”—Since conventional IdM provisioning processes are not well structured, areas or portions of these processes are not implemented on separate hardware/software platforms, with the ability to route an IdM request between these specialty platforms, enabling teams of experts in their area, to manage just their portion of the total IdM solution.

Conventional IdM technologies/solutions typically do not permit a solution topology where centralized teams of IdM resources can be organized by “subject matter expertise”, providing IdM deployment and support services, for one area of the solution, to multiple organizations.

No Seamless Cross Domain Capabilities—Conventional IdM provisioning solutions typically lack a seamless capability for deploying the solution across domains, or across organizational IT boundaries. An illustration of this in FIG. 1 would be if the source and target systems (7-11) of the solution existed in another IT domain, away from the rest of the solution (1-6, and A-E) and under control of a separate company. Access to the IT systems that IdM provisioning solutions must integrate with are typically not exposed to the internet and are protected from access by external systems.

Conventional solutions typically do not offer a connectivity component architecture permitting a bundle of connectivity components to be distributed into remote domains, enabling the establishment of secure channels between domains, where system specific connectivity components (7-11) may access designated target systems in remote domains.

Conventional solutions lack the cross domain capabilities described in the inventors copending application under “cross domain provisioning page 32-60.

A more complete treatment of cross domain capabilities may be found in the applicants' copending application Ser. No. 11/783,894 and entitled “CROSS DOMAIN PROVISIONING” filed on Apr. 12, 2007 by Saraswathy et al., which application is hereby incorporated by reference in its entirety.

No Rapid Deployment Methodology—Conventional IdM provisioning solutions rely upon custom scripts and customized programs to implement portions of their solution. They lack a design-time vs. run-time concept using a provisioning process configuration tool that offers a point & click approach to configuring provisioning processes. (they lack the tool described in the prior patent—Fundamental Operation—Design Time page 17, and Operation—Run Time page 22). Conventional solutions offer no ability to dynamically discover source and target system schema, a method for exposing the schema to a mapping tool, or a method for configuring transformation operations on IdM attributes between system schemas.

The illustrative implementation addresses each of these deficiencies as detailed below.

### Large Scale IdM (LSIdM)

For a large managed service provider (MSP) to be able to provide Large Scale IdM across large numbers of organizational units in a cost effective manner the conventional design for IdM systems needs to be improved and streamlined.

Rather than deploying an IdM solution for each organization, the MSP needs to build an IdM infrastructure that will provide IdM services to, for example, hundreds of client organizations.

The present illustrative implementation provides methods of designing, structuring and operating an IdM provisioning solution (one IdM solution) over multiple sets of hardware/software platforms, organized by “area of expertise”, to better utilize IdM deployment and support team resources for there subject matter expertise, improving quality, consolidating resources, and significantly reducing the cost of IdM deployment and operation, across the entire MSP customer base.

The illustrative implementation is organized into five sections each of which addresses one or more of the typical conventional solution deficiencies defined in the Conventional IdM section above. It should of course be recognized that illustrative implementations need not necessarily avoid each or any prescribed number of such deficiencies. The five sections of the following illustrative implementation include:
The IdM Provisioning Solution Model section that will typically address deficiency #4.
The Example LSIdM Infrastructure section that will typically address deficiencies #3.
The Service Provider Client Platform section that will typically address deficiencies #2, #7, and #8.
The Rapid Deployment Capabilities section that will typically address deficiency #7.
The LSIdM Platform Routing section that will typically address deficiencies #1, #5, and #6.

The illustrative implementation makes references to the applicants' copending application Ser. No. 11/783,894 and entitled “CROSS DOMAIN PROVISIONING METHODOLOGY AND APPARATUS” filed on Apr. 12, 2007 by Saraswathy et al., which application has been incorporated herein by reference in its entirety.

It refers to the following concepts, terms, figures, and pages from the copending application:
DataForum (Page 9, FIG. 1)
Fundamental Operation—Design-Time (Page-17, FIGS. 2, 3, 4)
Design-Time Client Workflow Configuration GUI Tool (Page-17)
IdM Mapping Methods (Page 20, 21)
Operation—Run-Time (Page-22, FIG. 5)
Connectivity Component Architecture (Page-27)
Connector (FIG. 6)
Cross Domain Provisioning (Page-32, FIG. 7)
Cross Domain Design-Time (Page-37)
Design-Time Step 1-5 (Pages 38-56)
Run-Time Step 1-5 (Pages 56-60)
Connected System Configuration File (FIG. 9)
Refresh Schema Request (FIG. 10)
Refresh Schema Response (FIG. 11)
Trigger Configuration (FIG. 12)
RDBMS Event Trigger (FIG. 13)
Import XML Stream (FIG. 14)

The illustrative implementation also assumes the use of similar technology described by the copending application technology is used herein.

### BRIEF DESCRIPTION OF THE DRAWINGS

FIG. 1 is an illustrative block diagram of a illustrative conventional IdM provisioning solution and platform;

FIG. 2 is an illustrative block diagram of an exemplary large scale IdM solution model;

FIG. 3 is an illustrative block diagram of another exemplary large scale IdM solution model;

FIG. 4 shows an illustrative example Large Scale IdM Infrastructure;

FIG. 5 is another example solution large scale IdM model;

FIG. 6 is an illustrative large scale IdM infrastructure showing an illustrative large scale IdM provisioning platform infrastructure coupled to an MSP client in another domain;

FIG. 7 is an illustrative block diagram showing large scale IdM provisioning platform routing.

### DETAILED DESCRIPTION OF ILLUSTRATIVE IMPLEMENTATION

IdM Provisioning Solution Models—In order to organize the LSIdM infrastructure by area of “subject matter expertise”, provisioning solutions preferably have a structure that permits distributing areas or portions of the IdM solution across multiple hardware/software platforms enabling IdM expert teams to manage just their portion(s) of the LSIdM. We refer to this solution structure as an IdM Solution Model.

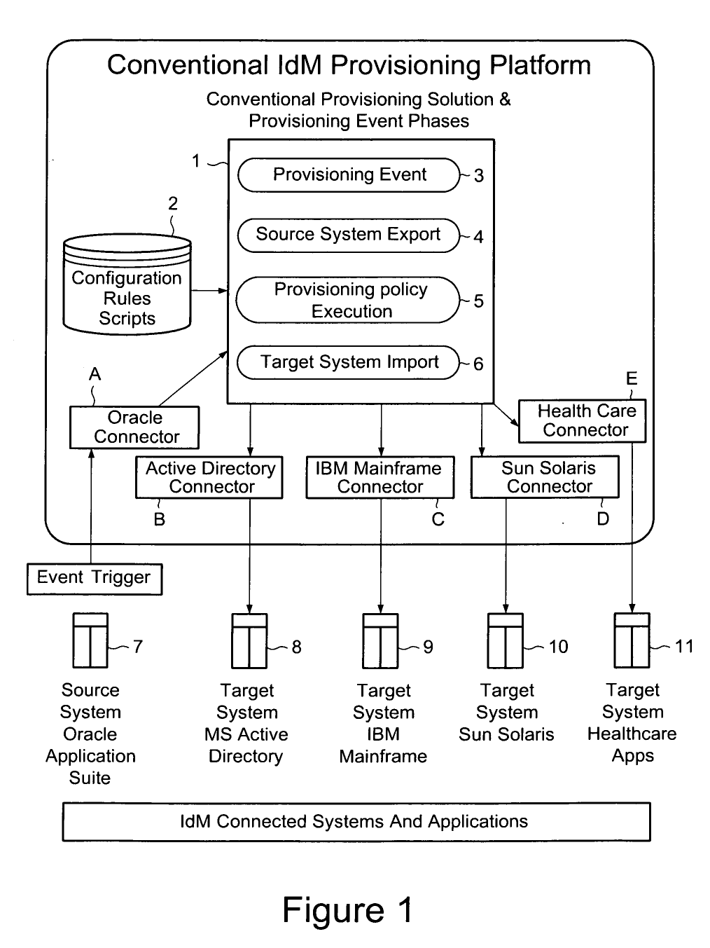

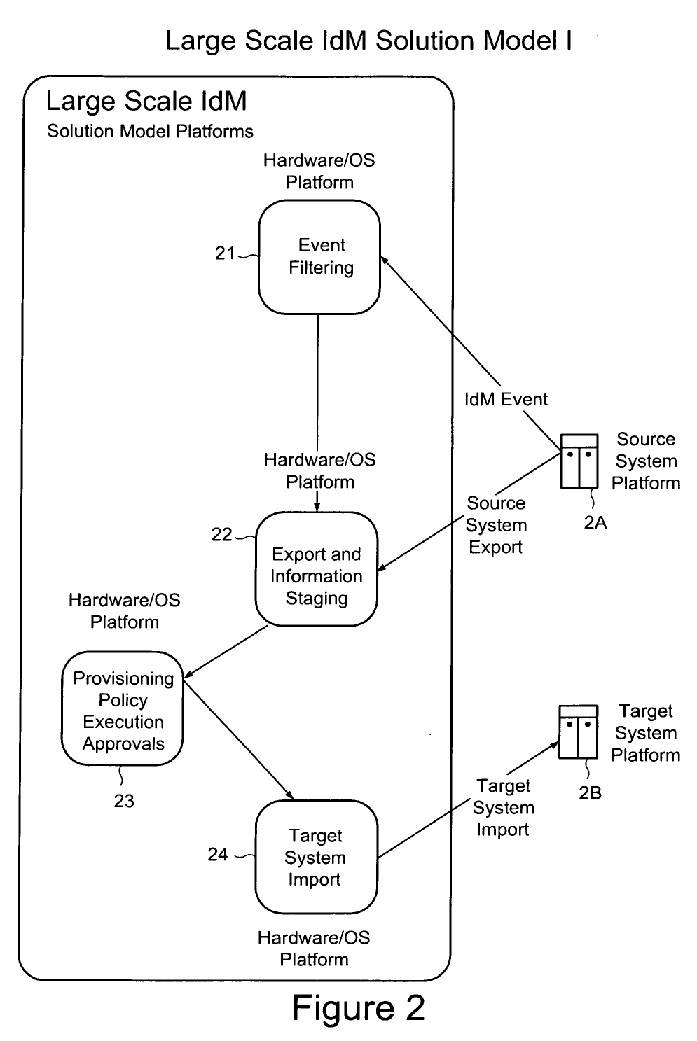

FIG. 2 contains an example of a 4-portion solution model, where the 4 portions correspond to the phases (3)-(6) in FIG. 1. Unlike the conventional IdM system of FIG. 1, these portions are implemented as separate processes architected to be installed on separate hardware and software platforms.

FIG. 2 illustrates the flow of IdM provisioning requests from one portion of a solution model to the next. For the example in FIG. 2, the IdM solution has a requirement for 2 connected systems, source system platform (2A), and target system platform (2B). IdM events originate in source system platform (2A); they flow into the LSIdM infrastructure to platform (21) where IdM event filtering occurs (solution model portion-1). The IdM request is then routed to platform (22) where source system lookups or source system exports occur (solution model portion-2). The request is then routed to platform (23) where provisioning policies or rules are applied to determine which accounts and/or entitlements need to be provisioned or de-provisioned in target connected systems. The request is then routed to platform (24) where target system imports are executed to accomplish the provisioning or de-provisioning activities (See LSIdM Platform Routing below). For conventional solutions, this same flow is described under Conventional IdM Provisioning Process Flow, except the conventional solution is not using a concept of solution models and therefore portions of the solution can not be distributed over “area of expertise” hardware and software platforms.

Using FIG. 2 we can identify the following “areas of expertise”:

1. Source System Platform (2A) integration

2. IdM provisioning solution behavior

3. Target System Platform (2B) integration

Source System Platform (2A) Integration—Technical resources with subject matter expertise on source system (2A) are assigned to this portion of the LSIdM infrastructure. On behalf of all MSP client organizations, this team is only responsible for integration with source system (2A), its security model, administration requirements, and the integration techniques or APIs used to accomplish integration. In FIG. 2, LSIdM platform (21) and platform (22) both have a requirement for integration with source system (2A). Platform (21) is receiving events from source system (2A); platform (22) is issuing lookups to system (2A).

IdM Provisioning Solution Behavior—LSIdM platform (23) is where the provisioning policies, rules, approvals, and configurations are executed. On behalf of all MSP client organizations, this team is only responsible for the solution behavior, the portion of the configuration that examines IdM events and transactions and through configuration determines which accounts and entitlements are to be provisioned or de-provisioned. This team doesn't need to affect those changes so they do not require subject matter expertise related to connected system integration.

Target System Platform (2B) Integration—Technical resources with subject matter expertise on target system (2B) are assigned to this platform. On behalf of all MSP client organizations, this team is only responsible for integration with target system (2B), its security model, administration requirements, and the integration techniques or APIs used to accomplish integration.

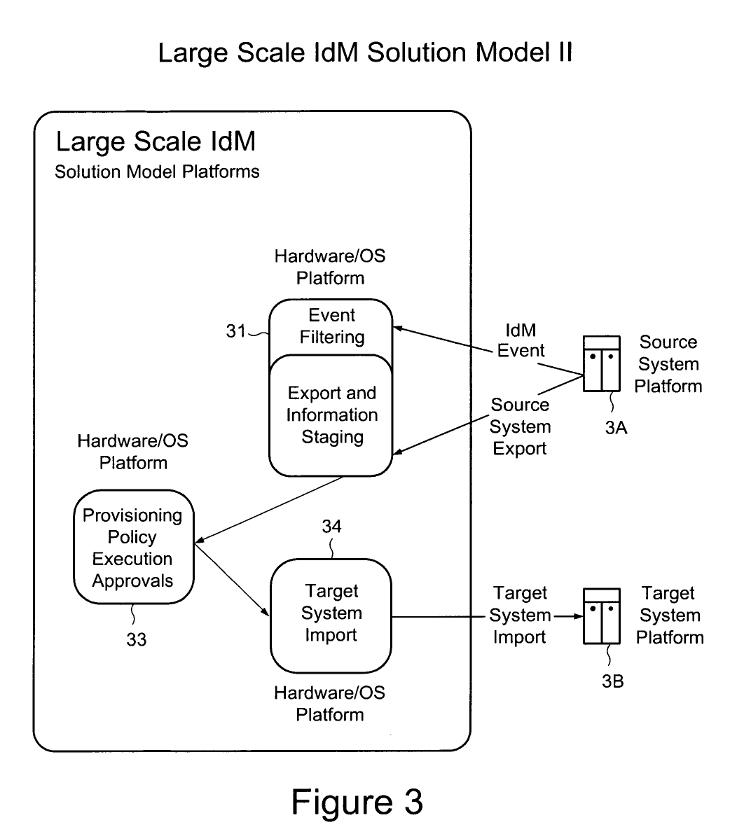

MSP's operating the LSIdM infrastructure have flexibility around solution models and how they distribute the portions of the IdM solution across hardware/software platforms. FIG. 3 is similar to FIG. 2 except solution model portion-1 (21) and solution model portion-2 (22) have been consolidated onto Hardware/OS Platform (31) in FIG. 3. Provisioning Policy Execution Approvals platforms 23 and 33 are equivalent platforms as are Target System Import platforms 24 and 34.

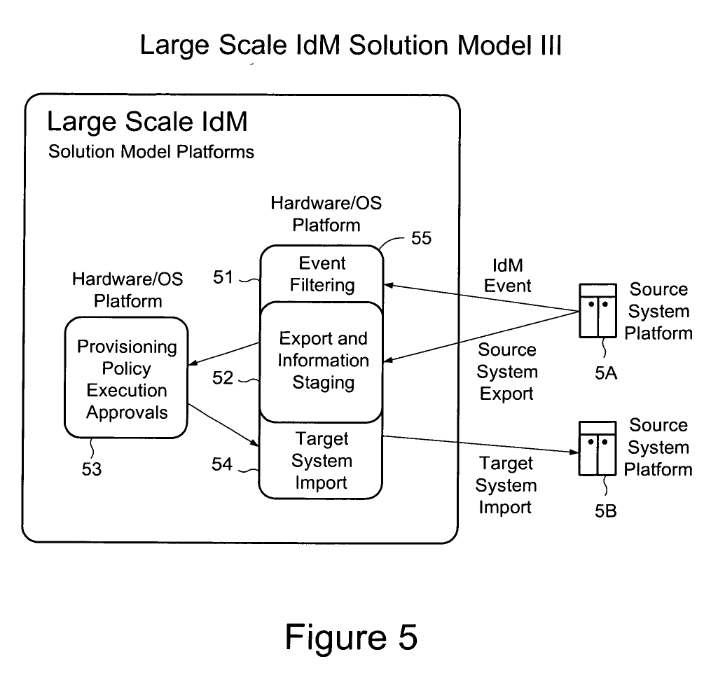

FIG. 5 is another example solution model that consolidates the portions of the solution model requiring system integration skill sets. Portion 1, 2, and 4 of the 4-part solution model have been consolidated onto one Hardware/OS Platform (51, 52, 54) as these portions require system specific integration skill sets. This can enable the MSP operating the LSIdM infrastructure to operate many of these system specific integration platforms, assigning IdM teams to these platforms, providing these system specific integration skills across the MSP client base.

Deficiencies Addressed:

Deficiency #4—Solution models permit the IdM solution to be partitioned into work function areas and technology areas where teams of solution area experts can focus their specialized skills and where costs can be shared across organizations, providing economies of scale that make LSIdM economically feasible.

Example LSIdM Infrastructure Section

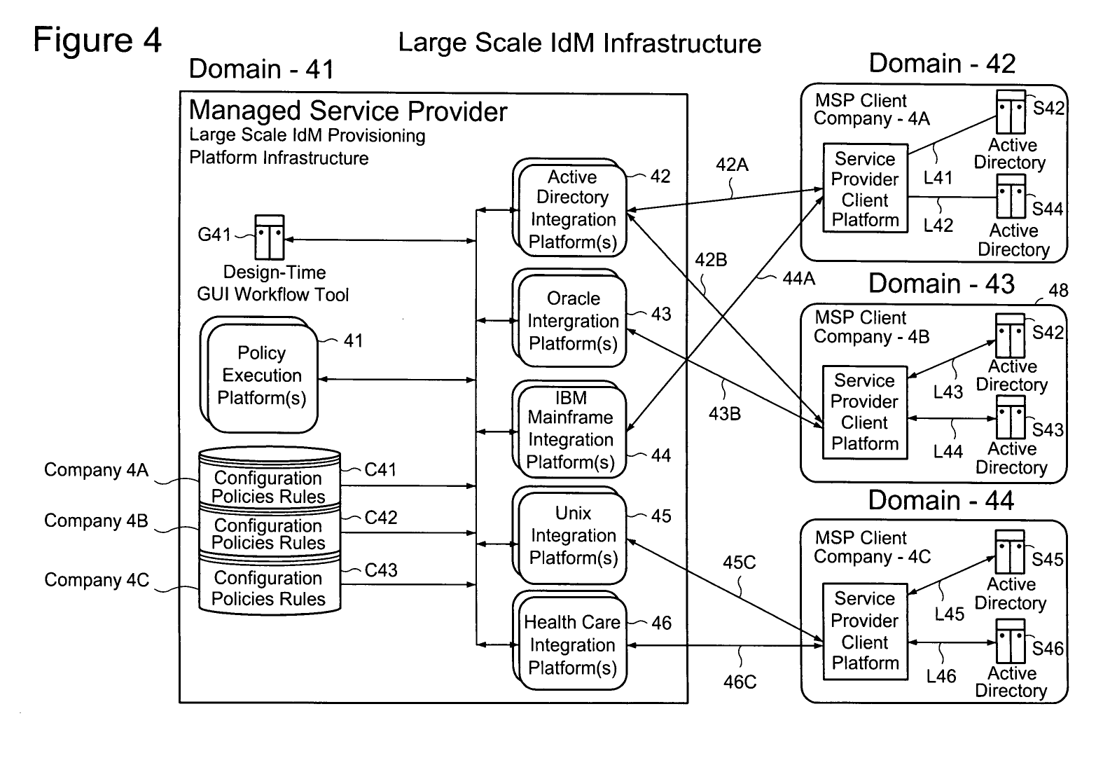

FIG. 4 shows an example Large Scale IdM Infrastructure using the solution model shown in FIG. 5, which can be used to demonstrate how teams of IdM resources can be organized by “area of expertise”. On the left we have the MSP hosting facility (Domain-41), where the LSIdM infrastructure is delivering IdM as a service to MSP Client domains on the right (Domain-42, 43, 44), for companies Company-4A, Company-4B, and Company-4C, with configuration policies and rules C41, C42 and C43 respectively, using the on-demand multi-tenancy delivery model. The source and target connected systems are in the remote MSP Client domains (Domain-42, 43, 44) on the right, where 3 client organizations are operating IT data centers.

Our example LSIdM infrastructure in FIG. 4 is assumed to be operating components of the Cross Domain Provisioning technology described by the inventors copending application as follows:

1. DataForum (copending application, Page 9, FIG. 1) operating on each of the Integration Platforms (2-6), and the Policy Execution Platform (1).

2. Design-Time Client Workflow Configuration GUI Tool (Page 17)

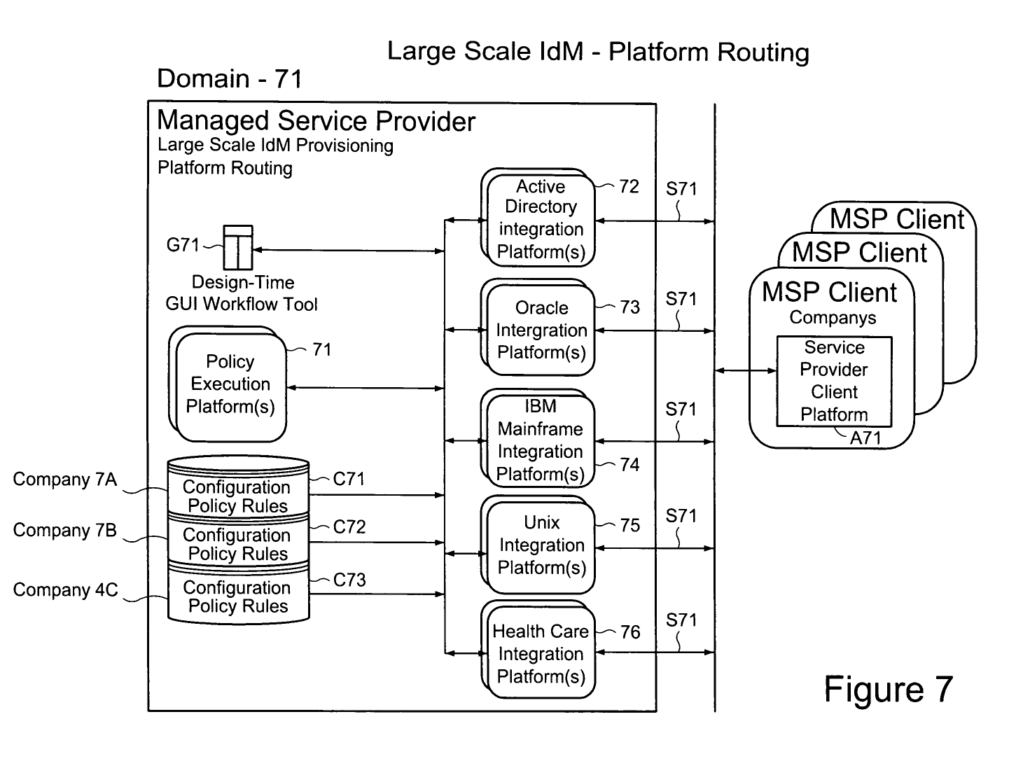

3. Cross Domain Provisioning (copending application, Page 32, FIG. 7) used to provision accounts between domain-1 and the target systems in the client domains (2-4) on the right.

The LSIdM infrastructure in FIG. 4 is organized into the following areas of expertise:
1. IdM Provisioning Solution Behavior and Configuration (FIG. 4, Domain-41, platform 41)
2. MS Active Directory Integration (FIG. 4, Domain-41, platform 42)
3. Oracle Application Integration (FIG. 4, Domain-41, platform 43)
4. IBM Mainframe Integration (FIG. 4, Domain-41, platform 44)
5. Unix Platform Integration (FIG. 4, Domain-41, platform 45)
6. Healthcare Applications (FIG. 4, Domain-41, platform 46)

FIG. 5, shows solution model portions-1, 2, and 4 consolidated on one platform 55. In FIG. 4, solution model portions-1, 2, and 4, are distributed to each of the system specific integration platforms (42-46). Solution model portion-3 is distributed to the Policy Execution Platform (41). The LSIdM infrastructure shown in FIG. 4 allows for 6 IdM deployment and support teams. Each of those teams uses the copending application GUI Configuration Tool (G1) differently. They also make use of the Cross Domain Provisioning concepts of the copending application:

1. Fundamental Operation—Design-Time (Copending application Page 17, FIGS. 2, 3, 4) to configure

2. IdM Mapping Methods (Page 20, 21)

Each deployment and support team (Teams 41-46 not shown) has a different area of IdM subject matter expertise, and uses the GUI tool to configure their portion of the solution model:
1. Policy Execution Platform(s) (41)—Managed by Team 41—uses the GUI Tool (G41) to configure the provisioning policies, rules, approvals, and the phase of the solution model that governs the behavior of a client organization's IdM solution. Relative to conventional solutions, Team 41 would be using the tool (G41) to address issues outlined in the Conventional IdM Provisioning Process Flow section, 3^{rd} the Policy Execution Phase (5) (see FIG. 1 above).
2. Active Directory Integration Platform(s) (42)—Managed by Team 42—Uses the GUI Tool (G41) to configure integration with Active Directory (S42), IdM event triggers, Active Directory Export and Staging operations, IdM mapping configurations between Active Directory and example provisioning engine schema shown in Table A.
3. Oracle Integration Platform(s) (43) Managed by Team 43—uses the GUI Tool (G41) to do the same configurations as Team-42 only for the Oracle Application Suite (S43).
4. IBM Mainframe Integration Platform(s) (44) Managed by Team 44—uses the GUI Tool (41) to do the same configurations as Team-42 only for instances of IBM Mainframes (S44).
5. Unix Integration Platforms(s) (45)—Managed by Team 45—uses the GUI Tool (G41) to do the same configurations as Team-42 only for instances of Unix platforms (S45).
6. Health Care Integration Platform(s) (46)—Managed by Team 46—uses the GUI Tool (G41) to do the same configurations as Team-42 only for integration with instances of Healthcare Applications (S46).

In FIG. 4, MSP Client Company-4B (48) (Domain-43) shows the use of the LSIdM infrastructure, associated platform teams, and flow of IdM transactions between domains and across these LSIdM platforms. In Domain-43, Company-4B (48) is running an instance of Active Directory (S42) and an instance of the Oracle Application suite (S43). Company-4B (48) requires support from Team 41 (platform 41) for their IdM provisioning policy configurations, Team 42 (platform 42) for their Active Directory integration and Team 43 (platform 43) for their Oracle Application suite integration.

Each of the three LSIdM platforms required for Company-4B (48) are running instances of DataForum described by the copending application. All three teams would use the Workflow GUI Tool (G41) to configure their portions of Company-4B's (48) IdM solution.

The section below on Rapid Deployment Capabilities covers more on how each team uses the GUI Tool (G41) to configure triggers, workflows, IdM policies and such. Also in Domain-43, Company-4B (48) has a Service Provider Client Platform (SPCP) containing Connectivity Components described by the copending application under “Connectivity Component Architecture” (Page 27), and “Cross Domain Provisioning” (Page 32, FIG. 7) described by the copending application is in use between Domain-1 and Domain-3. The use of the SPCP and Cross Domain provisioning by the LSIdM are described in more detail by Service Provider Client Platforms below.

For our example, we'll use Company-4B's (48) Oracle Application suite (S43) as a source of IdM events that need to be processed by the LSIdM infrastructure for Company-4B (48).

The flow:

1. As IdM events (New Hire, Termination, etc.) occur in Company-4B's (48) Oracle Application suite (S43), an IdM trigger configuration (configured by Team 43) causes the event data to be routed to the SPCP over the L44 communications channel.

2. The SPCP (Domain 43) routes the request over channel 43B to the Oracle Integration Platform (43) in Domain-41.

3. Event filtering occurs (Solution Model Portion-1), configured by Team 43.

4. After Oracle event filtering is complete, the request is passed to Solution Model Portion-2 (also implemented on the Oracle Integration Platform (43)) where exports can be executed from Company-4B's (48) Oracle suite (S43) and IdM event information can be staged for Provisioning Policy Execution.

5. The request is then routed to the Policy Execution Platform (41) where IdM provisioning configurations (by Team 41) can be applied to determine which Company-4B (48) systems need accounts and/or entitlements created or removed (Solution Model Portion-3). After provisioning policies are applied, Policy Execution configurations also determine which LSIdM platforms need to receive the request in order to affect target systems in other domains. If the client organization is running Active Directory, the request must go to the Active Directory Integration Platform (42). If the organization has an IBM Mainframe target, the request is also routed to the IBM Mainframe Integration Platform (44) and so on. In our example, Company-4B (48) is running Active Directory so the request is routed to the Active Directory Integration Platform (42).

6. On Platform (42), Team 42 configurations are used to execute Solution Model Portion-4. In our example, Active Directory Import operations are performed, targeting Company-4B's (48) instance of Active Directory (S42), over channel 42B, through Company-4B's (48) SPCP, and over channel L43. More detail on routing requests from platform to platform is covered in the LSIdM Platform Routing section below.

Deficiencies Typically Addressed:
Deficiency #3—The MSP operating the LSIdM infrastructure can assign IdM resources to the various platforms that support each portion of the solution model. This centralizes the use of IdM deployment and support resources. This enables the MSP to share the same resources across the solutions for multiple organizations, also maximizes the use of these resources, reducing the cost of IdM deployment and support across multiple organizations. The end results are economies of scale that make provision of Large IdM economically feasible.

Service Provider Client Platforms—In FIG. 1 we show integration between the conventional provisioning solution and connected systems (7-11) through the use of connectivity components (A-E) running on the provisioning platform.

In FIG. 4 we extended the conventional design by enabling the connected systems to run in MSP Client Domains, on the right. Each of the domains on the right contains a service provider client platform (SPCP). The SPCP serves as a secure gateway between each of the LSIdM platforms (42-46) in Domain-41, and the client specific IdM connected systems (S42-S46) in each of the MSP Client Domains on the right. FIG. 4 illustrates some of the possible connected systems that may be provisioned with this invention including Active Directory (S42), Oracle Application Suite (S43), IBM Mainframe(S44), Unix(S45) and Health Care (S46). This list is merely illustrative and is not intended to be comprehensive. A wide range of additional connected systems have been contemplated as would be apparent to those skilled in the art.

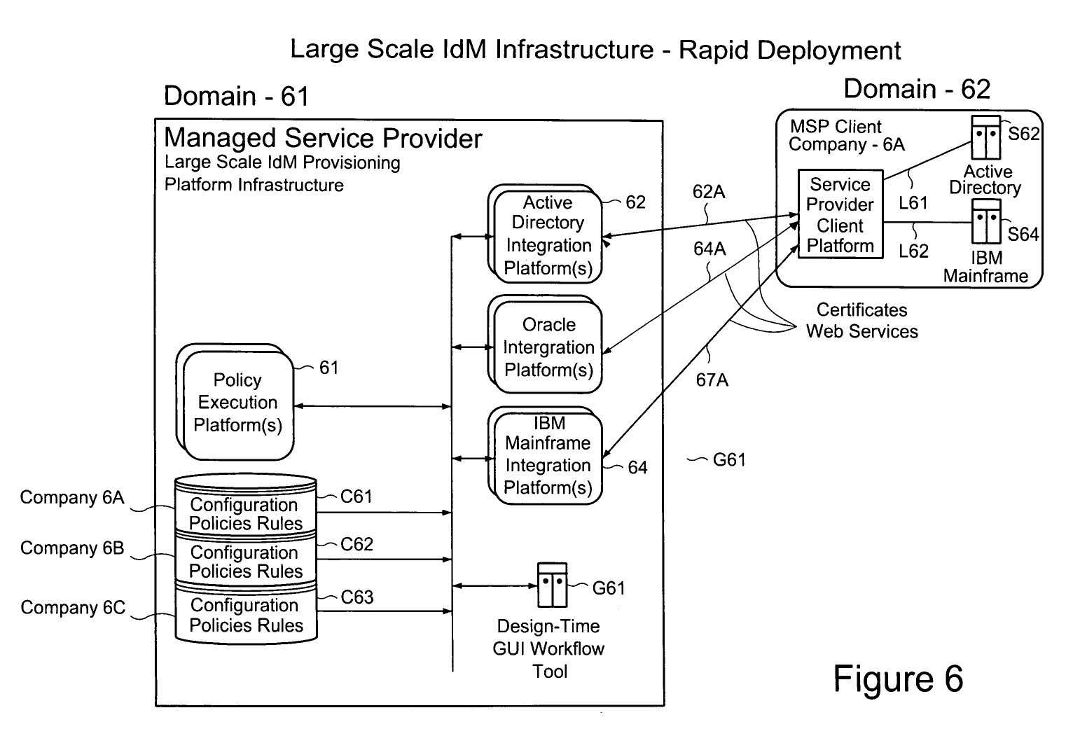

The arrows (42A, 44A, 42B, 43B, 45C, 46C) represent secure communications channels between Domain-41 running the LSIdM infrastructure, and the MSP Client Domains (Domain-42, 43, 44). The connectivity components (A-E) shown in FIG. 1 are bundled on the SPCPs in FIG. 4. Traffic flows between the LSIdM infrastructure on the left, over these secure channels (42A, 44A, 42B, 43B, 45C, 46C), through SPCPs, where the connectivity components can establish connectivity to the MSP Client's connected systems in the domains on the right. In order to accomplish this, the following capabilities are used from the copending application. Page numbers refer to the copending application:
Connectivity Component Architecture (Page 27)
Connector (FIG. 6)
Cross Domain Provisioning (Page 32, FIG. 7)
Cross Domain Design-Time (Page 37)

The connectivity component architecture permits us to distribute the connectivity components into MSP client domains on the SPCP platform, and the Cross Domain Design Time (copending application Page 37) is used to accomplish remote deployment to these IT systems by the LSIdM teams. The connector components on the SPCP platform are illustrated by the copending application FIG. 6. Cross Domain Provisioning (copending application Page 32, FIG. 7) is used during LSIdM operation to provision and de-provision accounts and entitlements in these target systems.

Each connected system is configured with a connector component. Each type of connected system has a connector that is capable of interconnecting that systems unique interfaces and environment into a consistent environment, such as the copending applications DataForum™ environment.

Deficiencies Typically Addressed:

Deficiency #2—The SPCP provides a methodology for accomplishing integration with the IT systems running in the domains of MSP client organizations. Without cross domain integration, the LSIdM infrastructure solution would not be able to create IdM accounts or assign entitlements and the on-demand delivery model typically would not be possible.

Deficiency #7—In addition to providing cross domain access to IT systems during operation, or run-time, the SPCP provides access during deployment (or solution design-time) to discover IT system schema, configure provisioning processes, and test various aspects of the provisioning solution. These capabilities are typically required for rapid and remote deployment of IdM solutions.

Deficiency #8—The SPCP provides seamless cross domain operation and integration to the client organization's IT systems.

Rapid Deployment Capabilities—Rapid deployment capabilities comprise: the ability to on-board new client organizations into a multi-tenancy LSIdM solution, the ability to use a point-n-click methodology to configure provisioning processes, and the ability to eliminate the programming and scripting associated with conventional IdM solutions. They are described in the copending application—Fundamental Operation-Design Time on page 17, and Operation-Run Time on page 22. These capabilities offer the ability to dynamically discover source and target system schema, a method for exposing the schema to a mapping tool such as the GUI mapping tool described in the copending application, and a method for configuring transformation operations on IdM attributes between system schemas, without programming or scripting.

To provide rapid deployment capabilities and the elimination of programming and scripting, the copending application describes a GUI tool used to manage these IdM configurations. The copending application also describes a provisioning engine called DataForum. The GUI tool is a client (of the DataForum (DF) engine. In FIG. 6 above, an instance of the DataForum (DF) provisioning engine is running on each of the LSIdM infrastructure platforms (61, 62, and 64).

Copending application FIGS. 3 and 4 illustrate a typical use of the GUI Tool.

Copending application FIG. 3 is an example GUI Tool screen showing a list of SunOne LDAP IdM attributes that were discovered using the copending application Design-Time schema discovery capabilities. These attributes can be selected as source attributes into a portion of a provisioning process.

Using solution model portion-2 (export and information staging), we can map and optionally transform these attributes to correspond to a schema such as the example schema shown in Table A which would be the target schema.

Copending application FIG. 4 shows another GUI Tool screen where mapping operations are configured. The screen shows a “Source Value” column, a “Mapping Rule” column, and a “Target Value” column. The “source value” column contains the source attributes that were selected by the GUI Tool; the “Target Value” column contains the target attributes. The “Mapping Rule” column contains a list of mapping, transformation, and lookup techniques that may be required to operate on these attributes. Using the 14^{th} row as and example—(Account-Password, Equals, userPassword—will make the target attribute equal to the equivalent source attribute.

FIG. 6 shows how rapid deployment and on-boarding of a new MSP client organization is possible using a GUI tool (G61) like the one described in the copending application, FIG. 6, LSIdM infrastructure is operating in the MSP domain-61 on the left. We'll add MSP Client Company-6A (Domain-62) as a new company which will be consuming the IdM service from the MSP. In Domain-61, three of the LSIdM platforms (61, 62, and 64) are used to illustrate on-boarding Company-6A (Domain-62). Domain-62 has two connected systems, Active Directory (S62), and IBM Mainframes (S64). The following rapid deployment process is followed:

1. The Service Provider Client Platform (SPCP) is shipped to Company-6A. Company-6A installs the SPCP software package in their web environment.

2. Since Company-6A is running Active Directory and IBM Mainframes, the MSP will use three LSIdM infrastructure teams to deploy the IdM solution for Company-6A:
a. Team 61—IdM Policy Execution Platform (61)
b. Team 62—Active Directory Integration Platform (62)
c. Team 64—IBM Mainframe Integration Platform (64)

These three teams will use the GUI tool (G61) to configure Company-6A's IdM solution across their designated platforms. These teams will work at the MSP Domain-1 with tool (G61) to configure the solution for Company-6A (Domain 62) remotely.

3. The MSP's Active Directory Integration Platform (62) team uses the GUI tool (G61) to:
a. Configure a PKI backed by an Oasis WS Security (WSS) channel between the Active Directory Integration Platform (62), running an instance of DF, and the SPCP running in Domain-62. To accomplish this, from a client workstation (FIG. 6 (G61)) at the MSP (Domain-61), the GUI tool configure a session with DF running on the Active Directory Integration Platform (62), and a standard WSS configuration is generated for WSS endpoints DF and SPCP. After the WSS configuration is completed, the GUI tool (G61) is used to establish a session with the SPCP and the WSS configuration is sent to the SPCP. Table B contains an example WSS configuration. At this point, a standard WSS channel has been established between Domain-61 and Domain-62, represented in FIG. 6 by arrow (62A).
b. Configure an Active Directory target system connection point. This is a configuration on the LSIdM Active Directory Integration Platform (62) (Domain-61) that contains the connection information and administrative credentials required to integrate with the instance of Active Directory running at Domain-62. Copending application FIG. 9 is an example of this configuration. After configuring the connection point, the GUI tool (G61) is used to test the connection point. The connection test flows from DF on Platform (62) Domain-61, over the secure channel (arrow (62A)), to SPCP in Domain-62, to the instance of Active Directory (S62). Copending application page 38, Design-Time Step 1—Create Connection Points, describes this process.
c. Configure the source and/or target system workflows described in the Example IdM Provisioning Infrastructure section above. Specifically solution model parts 51, 52, and 54 shown in FIG. 5. The GUI Tool (G61) is used to access the schema of these systems, bring the source and target system schema into the GUI Tool running on a client platform (G61), in Domain-61. The GUI Tool can then be used to configure source system exports and target system imports described by solution model portions-1, 2, and 4 above. Copending application section Design-Time Step 2—Connected System Refresh, page 40-54, describes a representative example of this process.
d. Configure IdM trigger configurations for Active Directory. Team-62 uses the GUI Tool to configure these trigger configurations. When changes occur in Active Directory (S62, Domain-62) the events are pushed through the SPCP to the LSIdM infrastructure in Domain-61. The copending application section Design-Time Step 5—Workflow Trigger Configuration, page-54, FIG. 12, reviews this process and shows a sample trigger configuration for a database.

4. The MSP's IBM Mainframe Integration Platform (64) team uses the GUI tool to do similar configurations as the Active Directory platform (62) team, only targeting IBM Mainframes. This team also configures the source and/or target system workflows described in the Example IdM Provisioning Infrastructure section above. Specifically solution model parts 51, 52, and 54 shown in FIG. 5, for IBM mainframe platforms.

5. The MSP's Policy execution platform (61) team uses the GUI tool (G61) to configure provisioning policies and rules that determine which target systems, and entitlements Company-6A's employees would have, based on IdM attributes, approval processes, and other IdM configurations. This team implements part 53 of the solution model in FIG. 5, “Provisioning Policy Execution Approvals”.

Deficiencies Typically Addressed:

Deficiency #7—Rapid Deployment—A GUI approach to configuration replacing the programming and scripting of conventional solutions significantly reduces the time to deploy and offers a graphical view of these IdM solutions. Without rapid deployment methodologies, the cost of on-boarding new client organizations typically would be prohibitive and those costs would render LSIdM financially infeasible.

LSIdM Platform Routing—The LSIdM infrastructure consists of many IdM provisioning platforms, each designated to provide support for a small portion of the infrastructure, also a small portion of the solution model, for multiple MSP client organizations. Again, each of the LSIdM platforms is being managed by separate “area of expertise” teams. Since the LSIdM infrastructure is spread across all of these platforms, IdM events must be routed across multiple LSIdM platforms.

The LSIdM infrastructure typically must be able to:
1. Associate each IdM event with an MSP client company.
2. Manage and apply MSP client company specific IdM configurations.
3. Route IdM events between LSIdM platforms.

FIG. 6 shows an example LSIdM infrastructure operating components of the technology described by the copending application as follows (page references are from the copending application):
DataForum (Page 9, FIG. 1), operating on each of the Integration Platforms (1-6).
Design-Time Client Workflow Configuration GUI Tool (Page 17), used by the LSIdM platform teams (G1).
Cross Domain Provisioning (Page 32, FIG. 7) used to provision accounts between the MSP domain and the domains of client organizations.

FIG. 7 shows 6 sets of IdM provisioning platforms (71-76) in the MSP Domain-71, multiple company configurations (C71, C72, C73), communications channels (S71) from remote MSP client domains, SPCP(s) running in remote MSP client domains (A71), described by Service Provider Client Platforms above.

Associating IdM Events With MSP Client Companies—In FIG. 7, as IdM events occur in MSP client company IT systems, IdM trigger configurations (described by Rapid Deployment Capabilities) cause the events to flow through a client company specific SPCP (A71), over a client company specific secure channel (S71), to one of the LSIdM platforms. The secure channel (S71) is a standard Oasis WS-Security (WSS) channel, using PKI backed security, as implemented, for example by the Apache WSS4j Project. Other security technologies that provide similar safeguards of authentication, data privacy and confidentiality can be used. The WSS endpoints consist of one of the LSIdM system specific integration platforms (72-76), and a specific client company instance of SPCP (A71). For example, each MSP Client company running Active Directory would have a separate WSS configuration specifying WSS endpoints for the LSIdM Active Directory Integration Platform (72) and the client company specific instance of SPCP (A71). The PKI backed security provides privacy across the WSS channel (S71) and a method of strong authentication for both WSS end points. This also enables the LSIdM integration platforms (72-76) to associate the IdM event with a specific MSP client company.

Manage and Apply MSP Client Company Specific IdM Configurations—In FIG. 7, as IdM events in MSP client company domains occur, they flow into one of the LSIdM system specific integration platforms (72-76). If the event occurred in an instance of Active Directory, the event flows into the LSIdM Active Directory Integration Platform (72). If it occurred in an Oracle application, it flows into the Oracle Integration Platform (73), and so on. The WSS channel (S71) is used to associate the event with a client company. The appropriate client company IdM configuration is selected (C71-C73). The IdM event trigger configuration, described under Rapid Deployment Capabilities above, contains an ID that is used to select the appropriate event filtering configuration (solution model portion-1). Copending application FIG. 12 serves as an example of a trigger configuration where the =Name field (Test MSSQL Trigger) might be used as the ID. The ID is also used to select the appropriate export and information staging configurations (solution model portion-2). Copending application FIG. 13, serves as an example of the trigger data that might flow into one of the LSIdM integration platforms (72-76). It can also serve as the IdM event data that is passed from solution model portion-1 to solution model portion-2.

Route IdM Events Between LSIdM Platforms—In FIG. 7, during solution model portion-2 processing, on one of the LSIdM integration platforms (72-76), IdM event information and additional IdM attributes that may have been exported, are mapped and transformed to an example schema represented by Table A. The schema in Table A contains a Company-Name attribute. The Company-Name attribute is populated and the example schema shown in Table A is routed to the LSIdM Policy Execution Platform (71) where the MSP client company IdM provisioning policies (C71-C73) are applied (solution model portion-3) This is explained more fully in IdM Provisioning Solution Models and Rapid Deployment Capabilities sections above.

The purpose of Policy Execution is to determine which accounts and/or entitlements need to be provisioned, or de-provisioned, in the MSP client company IT systems. In order to accomplish this, since the Policy Execution Platform doesn't actually perform these functions (Target System Import Operations, Solution Model Portion-4), the Policy Execution Platform determines which LSIdM platforms (2-6) need to process portion-4 of the solution model. The payload (Table A containing additional provisioning attributes, target system accounts, entitlements, IdM attribute changes) is routed to the appropriate LSIdM system specific integration platforms (72-76).

Each of the LSIdM system specific integration platforms (72-76) uses the Company-Name attribute (in Table A) to select the company specific target system import configurations (C71-C73) to execute MSP client company target system imports (solution model portion-4), over the (S71) channels, to client company IT systems. Copending application FIG. 14 can serve as example import data.

The method of routing between all of these LSIdM platforms is accomplished using the copending application Cross Domain Provisioning (Page 32, FIG. 7) feature. In our example in FIG. 7, all of the LSIdM platforms (71-76) reside in one domain. By using the Cross Domain Provisioning capabilities, the MSP can operate these LSIdM platforms in one domain, or in multiple domains.

Deficiencies Typically Addressed:
Deficiencies #1, #5, and #6—The MSP client company concept solves the problems preventing conventional solutions from providing feasible multi-tenancy operation (#1, and #6). The ability to route requests between the LSIdM platforms also permits the MSP to organize the infrastructure to assign teams that have “subject matter expertise” for their area of a solution (#5).

As presented, the illustrative implementation typically provides a solution to all the identified deficiencies present in conventional IdM implementations. The examples provided are for illustration and are not intended to be limiting. Other alternate implementations have been contemplated.

TABLE A
Example Identity Attribute Definition

<prio:root xmlns:prio=“http://www.fisc.com/agent/”>
<prio:attributes>

```
<prio:attribute>
    <prio:Abbr>Company-Name</prio:Abbr>
    <prio:Company>Company-Name</prio:Company>
</prio:attribute>
<prio:attribute>
    <prio:Abbr>Person-Firstname</prio:Abbr>
    <prio:Name>Person-Firstname</prio:Name>
</prio:attribute>
<prio:attribute>
    <prio:Abbr>Person-Lastname</prio:Abbr>
    <prio:Name>Person-Lastname</prio:Name>
</prio:attribute>
<prio:attribute>
    <prio:Abbr>Person-OriginalFirstname</prio:Abbr>
    <prio:Name>Person-OriginalFirstname</prio:Name>
</prio:attribute>
<prio:attribute>
    <prio:Abbr>Person-OriginalLastname</prio:Abbr>
    <prio:Name>Person-OriginalLastname</prio:Name>
</prio:attribute>
<prio:attribute>
    <prio:Abbr>Person-OriginalMiddlename</prio:Abbr>
    <prio:Name>Person-OriginalMiddlename</prio:Name>
</prio:attribute>
<prio:attribute>
    <prio:Abbr>Person-Middlename</prio:Abbr>
    <prio:Name>Person-Middlename</prio:Name>
</prio:attribute>
<prio:attribute>
    <prio:Abbr>Person-Fullname</prio:Abbr>
    <prio:Name>Person-Fullname</prio:Name>
</prio:attribute>
<prio:attribute>
    <prio:Abbr>Person-KnownAs</prio:Abbr>
    <prio:Name>Person-KnownAs</prio:Name>
</prio:attribute>
<prio:attribute>
    <prio:Abbr>Person-NickName</prio:Abbr>
    <prio:Name>Person-NickName</prio:Name>
</prio:attribute>
<prio:attribute>
    <prio:Abbr>Person-Email1</prio:Abbr>
    <prio:Name>Person-Email1</prio:Name>
</prio:attribute>
<prio:attribute>
    <prio:Abbr>Person-Email2</prio:Abbr>
    <prio:Name>Person-Email2</prio:Name>
</prio:attribute>
<prio:attribute>
    <prio:Abbr>Person-HomePhone</prio:Abbr>
    <prio:Name>Person-HomePhone</prio:Name>
</prio:attribute>
<prio:attribute>
    <prio:Abbr>Person-MobilePhone</prio:Abbr>
    <prio:Name>Person-MobilePhone</prio:Name>
</prio:attribute>
<prio:attribute>
    <prio:Abbr>Person-Gender</prio:Abbr>
    <prio:Name>Person-Gender</prio:Name>
</prio:attribute>
<prio:attribute>
    <prio:Abbr>Person-Street1</prio:Abbr>
    <prio:Name>Person-Street1</prio:Name>
</prio:attribute>
<prio:attribute>
    <prio:Abbr>Person-Street2</prio:Abbr>
    <prio:Name>Person-Street2</prio:Name>
</prio:attribute>
<prio:attribute>
    <prio:Abbr>Person-Street3</prio:Abbr>
    <prio:Name>Person-Street3</prio:Name>
</prio:attribute>
<prio:attribute>
    <prio:Abbr>Person-City</prio:Abbr>
    <prio:Name>Person-City</prio:Name>
</prio:attribute>
<prio:attribute>
    <prio:Abbr>Person-State</prio:Abbr>
    <prio:Name>Person-State</prio:Name>
</prio:attribute>
<prio:attribute>
    <prio:Abbr>Person-PostalCode</prio:Abbr>
    <prio:Name>Person-PostalCode</prio:Name>
</prio:attribute>
<prio:attribute>
    <prio:Abbr>Person-County</prio:Abbr>
    <prio:Name>Person-County</prio:Name>
</prio:attribute>
<prio:attribute>
    <prio:Abbr>Person-Country</prio:Abbr>
    <prio:Name>Person-Country</prio:Name>
</prio:attribute>
<prio:attribute>
    <prio:Abbr>Employee-Email1</prio:Abbr>
    <prio:Name>Employee-Email1</prio:Name>
</prio:attribute>
<prio:attribute>
    <prio:Abbr>Employee-Email2</prio:Abbr>
    <prio:Name>Employee-Email2</prio:Name>
</prio:attribute>
<prio:attribute>
    <prio:Abbr>Employee-Phone</prio:Abbr>
    <prio:Name>Employee-Phone</prio:Name>
</prio:attribute>
<prio:attribute>
    <prio:Abbr>Employee-PhoneExtension</prio:Abbr>
    <prio:Name>Employee-PhoneExtension</prio:Name>
</prio:attribute>
<prio:attribute>
    <prio:Abbr>Employee-MobilePhone</prio:Abbr>
    <prio:Name>Employee-MobilePhone</prio:Name>
</prio:attribute>
<prio:attribute>
    <prio:Abbr>Employee-Type</prio:Abbr>
    <prio:Name>Employee-Type</prio:Name>
</prio:attribute>
<prio:attribute>
    <prio:Abbr>Employee-Id</prio:Abbr>
    <prio:Name>Employee-Id</prio:Name>
</prio:attribute>
<prio:attribute>
    <prio:Abbr>Employee-Status</prio:Abbr>
    <prio:Name>Employee-Status</prio:Name>
</prio:attribute>
<prio:attribute>
    <prio:Abbr>Employee-StartDate</prio:Abbr>
    <prio:Name>Employee-StartDate</prio:Name>
</prio:attribute>
<prio:attribute>
    <prio:Abbr>Employee-EndDate</prio:Abbr>
    <prio:Name>Employee-EndDate</prio:Name>
</prio:attribute>
<prio:attribute>
    <prio:Abbr>Employee-KeyValue</prio:Abbr>
    <prio:Name>Employee-KeyValue</prio:Name>
</prio:attribute>
<prio:attribute>
    <prio:Abbr>Employee-PrincipalName</prio:Abbr>
    <prio:Name>Employee-PrincipalName</prio:Name>
</prio:attribute>
<prio:attribute>
    <prio:Abbr>Job-Name</prio:Abbr>
    <prio:Name>Job-Name</prio:Name>
</prio:attribute>
<prio:attribute>
    <prio:Abbr>Job-Title</prio:Abbr>
    <prio:Name>Job-Title</prio:Name>
</prio:attribute>
<prio:attribute>
    <prio:Abbr>Job-Description</prio:Abbr>
    <prio:Name>Job-Description</prio:Name>
</prio:attribute>
<prio:attribute>
    <prio:Abbr>Job-LongDescription</prio:Abbr>
    <prio:Name>Job-LongDescription</prio:Name>
</prio:attribute>
<prio:attribute>
    <prio:Abbr>Job-Organization</prio:Abbr>
    <prio:Name>Job-Organization</prio:Name>
</prio:attribute>
<prio:attribute>
    <prio:Abbr>Job-Department</prio:Abbr>
    <prio:Name>Job-Department</prio:Name>
</prio:attribute>
<prio:attribute>
    <prio:Abbr>Job-Salary</prio:Abbr>
    <prio:Name>Job-Salary</prio:Name>
</prio:attribute>
<prio:attribute>
    <prio:Abbr>Job-Manager</prio:Abbr>
    <prio:Name>Job-Manager</prio:Name>
</prio:attribute>
<prio:attribute>
    <prio:Abbr>Job-Supervisor</prio:Abbr>
    <prio:Name>Job-Supervisor</prio:Name>
</prio:attribute>
<prio:attribute>
    <prio:Abbr>Job-Grade</prio:Abbr>
    <prio:Name>Job-Grade</prio:Name>
</prio:attribute>
<prio:attribute>
    <prio:Abbr>Job-Status</prio:Abbr>
    <prio:Name>Job-Status</prio:Name>
</prio:attribute>
<prio:attribute>
    <prio:Abbr>Location-Street1</prio:Abbr>
    <prio:Name>Location-Street1</prio:Name>
</prio:attribute>
<prio:attribute>
    <prio:Abbr>Location-Street2</prio:Abbr>
    <prio:Name>Location-Street2</prio:Name>
</prio:attribute>
<prio:attribute>
    <prio:Abbr>Location-Street3</prio:Abbr>
    <prio:Name>Location-Street3</prio:Name>
</prio:attribute>
<prio:attribute>
    <prio:Abbr>Location-POBox</prio:Abbr>
    <prio:Name>Location-POBox</prio:Name>
</prio:attribute>
<prio:attribute>
    <prio:Abbr>Location-County</prio:Abbr>
    <prio:Name>Location-County</prio:Name>
</prio:attribute>
<prio:attribute>
    <prio:Abbr>Location-Province</prio:Abbr>
    <prio:Name>Location-Provence</prio:Name>
</prio:attribute>
<prio:attribute>
    <prio:Abbr>Location-City</prio:Abbr>
    <prio:Name>Location-City</prio:Name>
</prio:attribute>
<prio:attribute>
    <prio:Abbr>Location-State</prio:Abbr>
    <prio:Name>Location-State</prio:Name>
</prio:attribute>
<prio:attribute>
    <prio:Abbr>Location-PostalCode</prio:Abbr>
    <prio:Name>Location-PostalCode</prio:Name>
</prio:attribute>
<prio:attribute>
    <prio:Abbr>Location-Territory</prio:Abbr>
    <prio:Name>Location-Territory</prio:Name>
</prio:attribute>
<prio:attribute>
    <prio:Abbr>Location-Region</prio:Abbr>
    <prio:Name>Location-Region</prio:Name>
</prio:attribute>
<prio:attribute>
    <prio:Abbr>Location-Building</prio:Abbr>
    <prio:Name>Location-Building</prio:Name>
</prio:attribute>
<prio:attribute>
    <prio:Abbr>Location-OfficeNumber</prio:Abbr>
    <prio:Name>Location-OfficeNumber</prio:Name>
</prio:attribute>
<prio:attribute>
    <prio:Abbr>Location-Zone</prio:Abbr>
    <prio:Name>Location-Zone</prio:Name>
</prio:attribute>
<prio:attribute>
    <prio:Abbr>Location-ID</prio:Abbr>
    <prio:Name>Location-ID</prio:Name>
</prio:attribute>
<prio:attribute>
    <prio:Abbr>Account-ID</prio:Abbr>
    <prio:Name>Account-ID</prio:Name>
</prio:attribute>
<prio:attribute>
    <prio:Abbr>Account-Enabled</prio:Abbr>
    <prio:Name>Account-Enabled</prio:Name>
</prio:attribute>
<prio:attribute>
    <prio:Abbr>Account-Locked</prio:Abbr>
    <prio:Name>Account-Locked</prio:Name>
</prio:attribute>
<prio:attribute>
    <prio:Abbr>Account-RoleName</prio:Abbr>
    <prio:Name>Account-RoleName</prio:Name>
</prio:attribute>
<prio:attribute>
    <prio:Abbr>Account-RoleDesc</prio:Abbr>
    <prio:Name>Account-RoleDesc</prio:Name>
</prio:attribute>
<prio:attribute>
    <prio:Abbr>Account-GroupName</prio:Abbr>
    <prio:Name>Account-GroupName</prio:Name>
</prio:attribute>
<prio:attribute>
    <prio:Abbr>Account-GroupDesc</prio:Abbr>
    <prio:Name>Account-GroupDesc</prio:Name>
</prio:attribute>
<prio:attribute>
    <prio:Abbr>Account-UserName</prio:Abbr>
    <prio:Name>Account-UserName</prio:Name>
</prio:attribute>
<prio:attribute>
    <prio:Abbr>Account-Password</prio:Abbr>
    <prio:Name>Account-Password</prio:Name>
</prio:attribute>
<prio:attribute>
    <prio:Abbr>Account-UserID</prio:Abbr>
    <prio:Name>Account-UserID</prio:Name>
</prio:attribute>
<prio:attribute>
    <prio:Abbr>Account-DisplayName</prio:Abbr>
    <prio:Name>Account-DisplayName</prio:Name>
</prio:attribute>
<prio:attribute>
    <prio:Abbr>Account-Status</prio:Abbr>
    <prio:Name>Account-Status</prio:Name>
</prio:attribute>
<prio:attribute>
    <prio:Abbr>Account-Class</prio:Abbr>
    <prio:Name>Account-Class</prio:Name>
</prio:attribute>
<prio:attribute>
    <prio:Abbr>Account-DN</prio:Abbr>
    <prio:Name>Account-DN</prio:Name>
</prio:attribute>
<prio:attribute>
    <prio:Abbr>Account-baseDN</prio:Abbr>
    <prio:Name>Account-baseDN</prio:Name>
</prio:attribute>
<prio:attribute>
    <prio:Abbr>Account-EmailDomain</prio:Abbr>
    <prio:Name>Account-EmailDomain</prio:Name>
</prio:attribute>
<prio:attribute>
    <prio:Abbr>Account-userBaseDN</prio:Abbr>
    <prio:Name>Account-userBaseDN</prio:Name>
</prio:attribute>
<prio:attribute>
    <prio:Abbr>Account-Description</prio:Abbr>
    <prio:Name>Account-Description</prio:Name>
</prio:attribute>
</prio:attributes>
```

</prio:root>

TABLE B
Example WSS Configuration for GIG end points

<wssconfig>
<target id=“MSP_GUI_TOOL” >
<parameter name=“communicationEnable” value=“false”/>
<parameter
name=“targetUserName” value=“MSP_GUI_TOOLToken”/>
<parameter name=“targetType” value=“GUI TOOL”/>
<parameter name=“targetPassword” value=“XllWVltWWV5dVw==”/>
</target>
<global>
<parameter name=“endPointType” value=“SPCP_GATEWAY”/>
<parameter name=“keyStorePassword” value=“XlxfVllXWVdcVg==”/>
<parameter
name=“endPointId” value=“COMPANY-A_SPCP_GATEWAY”/>
<parameter name=“port” value=“8080”/>
<parameter name=“useSSL” value=“false”/>
<parameter name=“username” value=“WSS user
name token COMPANY-
A_SPCP_GATEWAYToken”/>
<parameter name=“hostname” value=“PQR”/>
<parameter name=“endPointEnable” value=“true”/>
<parameter name=“keyStorePath”
value=“c:\COMPANYA\SPCP\
GATEWAY\config\PQR_DF_GIG.kdb”/>
<parameter name=“password” value=“XlheXFpaXFxaWg==”/>
</global>
<target id=“MSP_DF_AD_Integration_Platform” >
<parameter name=“communicationEnable” value=“false”/>
<parameter name=“targetUserName” value=“ProvisioningToken”/>
<parameter name=“targetType” value=“DFSERVER”/>
<parameter name=“targetPassword” value=“Xl9XWF5XXldcWQ==”/>
</target>
</wssconfig>

1. In a computer system having a plurality of computers including a source system computer communicating with a target system computer, a method of processing identity management events comprising:
receiving an identity management event from a source system computer by an identity management computer system;
processing said identity management event by a first computing platform embodied in said identity management computer system by integrating source system computer-related information with said identity management event;
determining provisioning rules to be applied to said identity management event by an identity management provisioning policy approval second computing platform embodied in said identity management computer system; and
executing provisioning tasks related to said identity management event from said source system with respect to a target system by said identity management computer system.

2. A method according to claim 1, wherein said step of processing said identity management event by a first computing platform includes the step of processing information relating to the source system's security model.

3. A method according to claim 1, wherein said step of processing said identity management event by a first computing platform includes the step of processing information relating to the source system's administrative requirements.

4. A method according to claim 1, wherein said step of processing said identity management event by a first computing platform includes the step of communicating with the source system to retrieve source system information.

5. A method according to claim 1, wherein said step of determining provisioning rules to be applied to said identity management event includes the step of examining the identity management event and determining accounts and entitlements to be provisioned.

6. A method according to claim 1, wherein said step of executing provisioning tasks with respect to a target system includes the step of processing information relating to a target system's security model.

7. A method according to claim 1, wherein said step of executing provisioning tasks with respect to a target system includes the step of processing information relating to a target system's administrative requirements.

8. A method according to claim 1, further including the step of analyzing the incoming identity management event.

9. A method according to claim 1, where said step of executing provisioning tasks with respect to a target system includes the step of utilizing a target system computing platform embodied in said identity management computer system.

10. A method according to claim 1, where said step of executing provisioning tasks with respect to a target system includes the step of utilizing said first computing platform to perform target system tasks.

11. A method according to claim 1, further including the step of assigning to said first computing platform a first set of tasks in a first defined area of expertise and assigning said second computing platform a second set of tasks in a second defined area of expertise.

12. An identity management computer system for processing identity management events received from a source system computer, said identity management computer system comprising:
a receiver for receiving an identity management event from a source system by said identity management computer system;
a first computing platform embodied in said identity management computer system for processing said identity management event by integrating source system computer-related information with said identity management event; and
a second identity management provisioning policy approval computing platform for determining provisioning rules to be applied to said identity management event;
said identity management computer system being operable to execute provisioning tasks related to said identity management event from said source system with respect to a target system.

13. An identity management computer system according to claim 12, wherein said first computing platform is operable to process information relating to the source system's security model.

14. An identity management computer system according to claim 12, wherein said first computing platform is operable to process information relating to the source system's administrative requirements.

15. An identity management computer system according to claim 12 wherein said first computing platform is operable to retrieve source system information.

16. An identity management computer system according to claim 12, wherein said second identity management provisioning policy approval computing is operable to examine the identity management event and determine accounts and entitlements to be provisioned.

17. An identity management computer system according to claim 12, wherein the execution of provisioning tasks with respect to a target system includes processing information relating to a target system's security model.

18. An identity management computer system according to claim 12, wherein the execution of provisioning tasks with respect to a target system includes processing information relating to a target system's administrative requirements.

19. An identity management computer system according to claim 12, further including a third computing platform for executing provisioning tasks with respect to said target system

20. A large scale identity management computing system for servicing identity management tasks of a first client computing system and a second client computing comprising:
a first computing platform for processing identity management tasks from a first client computing system and for processing identity management tasks from a second client computing system; and
a second identity management provisioning policy execution computing platform for determining provisioning rules to be applied to said identity management tasks from said first client computing system and said second client computing system.

21. A large scale identity management computing system according to claim 20, wherein each of said first client computing system and said second client computing system include:
a client specific computing system, and
a service provider client platform serving as a secure gateway between said first computing platform and said client specific computing system.

22. A large scale identity management computing system according to claim 20, wherein said first computing platform is a health care integration platform and said first client computing system executes health care applications.

23. A large scale identity management computing system according to claim 20, wherein said first computing platform is an IBM mainframe integration platform.

24. A large scale identity management computing system according to claim 20, wherein said second identity management provisioning policy execution computing platform for determining provisioning rules is operable to configure the provisioning rules to govern the identity management solutions of at least one said first client computing system and said second client computing system.

25. A large scale identity management computing system according to claim 20, further including graphic user interface tools, wherein said second identity management provisioning policy execution computing platform for determining provisioning rules is operable in response to said graphic user interface tools to configure the provisioning rules to govern the identity management solutions of at least one of said first client computing system and said second client computing system.
